(19) United States
(12) Patent Application Publication
(10) Pub. No.: US 2012/0314785 A1
(43) Pub. Date: Dec. 13, 2012

(54) Method for Data Transmission and Data Transmission System

(75) Inventor: Zhidong Hua, Karlsruhe (DE)

(73) Assignee: SEW-EURODRIVE GMBH & CO. KG, Bruchsal (DE)

(21) Appl. No.: 13/522,443

(22) PCT Filed: Jan. 10, 2011
(86) PCT No.: PCT/EP2011/000053

§ 371 Date: Jul. 16, 2012

(30) Foreign Application Priority Data
Jan. 15, 2010 (DE) 10 2010 004 829.1

(51) Int. Cl. H04L 27/28; H04L 27/00

(52) U.S. Cl. 375/260; 375/295

(57) ABSTRACT

In a method for data transmission by orthogonal frequency multiplexing (OFDM) between a transmitter and a receiver using a data signal, the data signal having a telegram, which is made up of OFDM symbols, the OFDM symbols are transmitted by the transmitter in symbol-wise fashion at a rate of repetition n-fold in succession within the telegram, and in the process of receiving in the receiver, the respectively n-fold successively transmitted OFDM symbols are added symbol-wise in phase.

### FIELD OF THE INVENTION

The present invention relates to a method for data transmission and a data transmission system.

### BACKGROUND INFORMATION

Methods for data transmission using orthogonal frequency multiplexing are generally known.

European Published Patent Application No. 2 048 845 describes techniques for correcting the amplitude damping effect in OFDM signals.

European Published Patent Application No. 2 071 757 relates to a device and a method for transmitting and receiving OFDM symbols.

German Published Patent Application No. 101 63 342 relates to a serial bus system, in which data are transmitted to the connected passive bus stations in the form of telegrams, which represent process images.

German Published Patent Application No. 103 49 242 relates to a device and a method for the contactless transmission of electrical power and information.

### SUMMARY

Example embodiments of the present invention make a method for data transmission and a data transmission system more reliable.

Features of example embodiments of the present invention in the method for data transmission by orthogonal frequency multiplexing (OFDM) between a transmitter and a receiver using a data signal are that the data signal has a telegram, which is made up of OFDM symbols, the OFDM symbols being transmitted by the transmitter in symbol-wise fashion at rate of repetition n-fold in succession within the telegram, and in the process of receiving in the receiver, the respectively n-fold successively transmitted OFDM symbols being added symbol-wise in phase. It is advantageous in this regard that the method for data transmission is more reliable and error-resistant since the signal-to-noise ratio is improved.

The rate of repetition may be ascertained as a function of a transmission characteristic of a transmission medium of the data signal. It is advantageous in this regard that the error-resistance is set in optimized fashion and that the bandwidth of the transmission medium is utilized in optimized fashion.

A test signal may be transmitted in an initialization of the method, an evaluation device in the receiver determines a signal strength, in particular an amplitude of the test signal, and either the evaluation device determines the rate of repetition of the OFDM symbols from the signal strength and the receiver communicates the rate of repetition to the transmitter, or the receiver transmits the signal strength to the transmitter and an additional evaluation device in the transmitter determines the rate of repetition of the OFDM symbols from the signal strength. It is advantageous in this regard that the rate of repetition is dynamically adaptable to the existing transmission medium.

The test signal may be a signal with a chirp. It is advantageous in this regard that when using a signal with a chirp as a test signal, a wide frequency range is tested.

The rate of repetition for different transmission frequencies may be ascertained separately. It is advantageous in this regard that the bandwidth is used in optimized fashion and that nevertheless all channels are transmittable with the required error-resistance.

A disturbance detector in the receiver and/or in the transmitter may detect a time-related impulsive disturbance in the transmission medium and either the rate of repetition of the OFDM symbols may be determined as a function of the rate of occurrence of the time-related impulsive disturbance or the rate of repetition of the OFDM symbols may be determined as a function of the signal strength and the rate of occurrence of the time-related impulsive disturbances. The advantage in this regard is that the rate of repetition of disturbances in the transmission medium is adaptable in the frequency range and in the time range.

In the event of a change of a transmission route for the data signal due to a movement of the transmitter and/or the receiver, the transmitter may detect the change, and an initialization may be performed. It is advantageous in this regard that the rate of repetition is dynamically adaptable and thus the bandwidth is used in optimized fashion.

Features in a method for data transmission by an OFDM method between a transmitter and a receiver and for electrical energy transmission are that the data transmission using an alternating current component and the energy transmission using another alternating current component use at least partly the same line, a data signal being made up of OFDM symbols for the purpose of data transmission and the additional alternating current component having a frequency such that the length in time of an OFDM symbol corresponding to a half period of the frequency. It is advantageous in this regard that, in spite of the great disturbances produced by the energy transmission in the line, an error-resistant data transmission over the same line is possible.

In a method for data transmission by an OFDM method between a transmitter and a receiver and for electrical energy transmission, the OFDM symbols are transmitted symbol-wise at a rate of repetition n-fold in succession, and when they are received, the OFDM symbols, which are repeatedly transmitted in succession, are added symbol-wise in phase. It is advantageous in this regard that the method for data transmission is error-resistant since the signal-to-noise ratio is greater.

In a method for data transmission by an OFDM method between a transmitter and a receiver and for electrical energy transmission, the additional alternating current component is fed into the same line and the data signal is fed in and coupled out of the same line in a contactless manner. It is advantageous in this regard that only one single line is required for data transmission and energy transmission and that the data transmission is error-resistant.

Features of the data transmission system are that the data transmission system includes device(s) for performing the steps of the method for data transmission. It is advantageous in this regard that the data transmission is more reliable.

Features in a device having transmitters and receivers, in particular as the data transmission system, are that the transmitters and/or receivers are moved relative to a line and communicate among one another and with a control unit via the line using a method for data transmission. It is advantageous in this regard that the data transmission is dynamically adaptable so as to utilize the bandwidth in optimized fashion.

Features in a device having consumers movable along an extended closed conductor loop are that an alternating current component in a frequency range in the conductor loop is used for data transmission, an additional alternating current component being fed into the conductor loop at a frequency for energy transmission, the consumers each having a secondary winding, from which the respective consumer is supplied with energy, the secondary winding being coupled inductively to the conductor loop and a capacitor being connected in series and/or in parallel to the secondary winding such that a resonant frequency of the circuit made up of secondary winding and capacitor has a resonant frequency that corresponds to the frequency, the consumers respectively and/or the control unit having the data transmission system. It is advantageous in this regard that an error-resistant data transmission is possible despite strong disturbance signals in the conductor loop or line.

The device may be arranged as a monorail conveyor and the consumers respectively may include a motor and a traveling carriage. It is advantageous in this regard that the traveling carriages are reliably supplied with energy over a single line and are controllable over the same line in an error-resistant manner by data transmission.

### LIST OF REFERENCE NUMERALS

1 first modem

2 second modem

3 line

5 data transmission system

10 transmitter

12 receiver

14 telegram

15 ID OFDM symbol

16 command OFDM symbol

18 CRC OFDM symbol

20 additional transmitter

22 additional receiver

30 first transmission buffer

31 first current driver

32 additional evaluation device

34 first receiving buffer

36 first bandpass filter

38 first receiving amplifier

40 first coupling device

41 additional first coupling device

50 second transmission buffer

51 second current driver

52 evaluation device

54 second receiving buffer

56 second band-pass filter

58 second receiving amplifier

60 second coupling device ⊕additional second coupling device

Example embodiments of the present invention will now be explained in greater detail below with reference to the appended Figures.

### BRIEF DESCRIPTION OF THE DRAWINGS

FIG. 1 is a schematic representation of a data transmission system.

FIG. 2 schematically illustrates the structure of a telegram.

### DETAILED DESCRIPTION

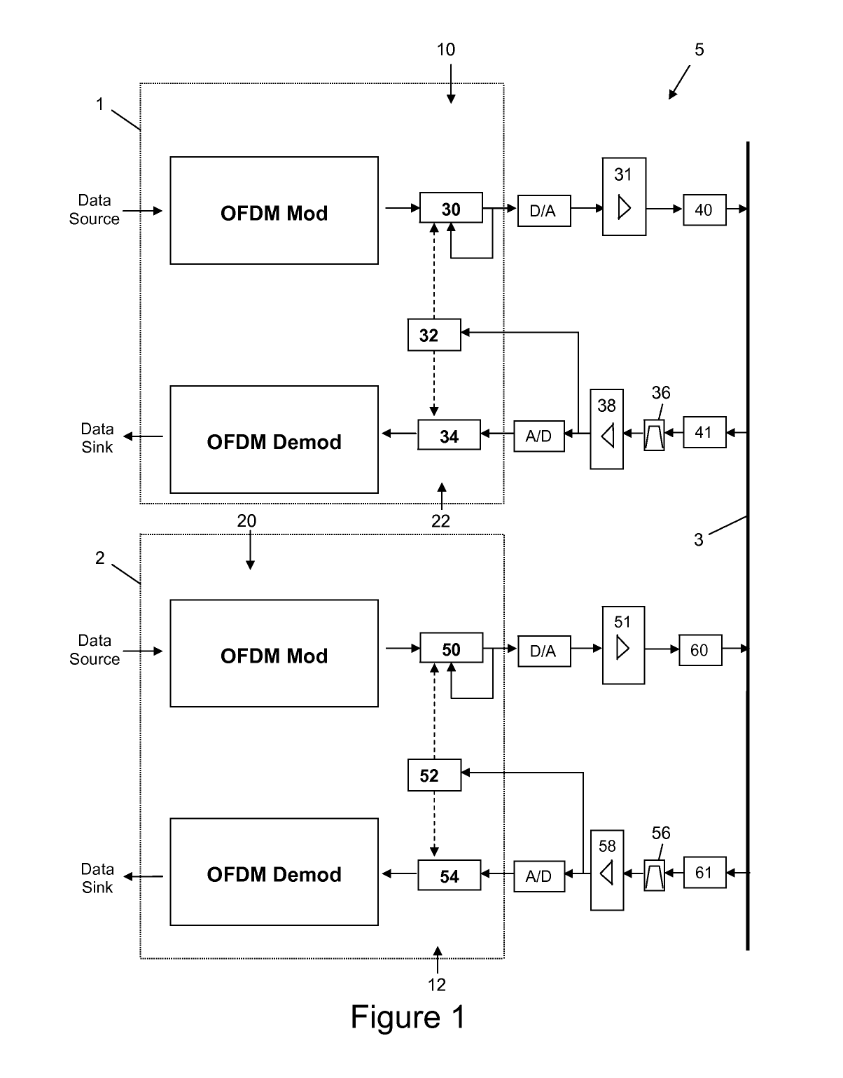

FIG. 1 shows a data transmission system 5, which exchanges data by a telegram 14 over a line 3 between a first modem 1 and a second modem 2 over a line 3. Data transmission system 5 allows for a method for data transmission preferably by orthogonal frequency multiplexing (OFDM).

First modem 1 has a transmitter 10 and an additional receiver 22, which are built to produce and process OFDM symbols. For this purpose, transmitter 10 converts the data of a data source using an OFDM modulator into OFDM symbols, which are arranged in a telegram 14.

A telegram 14 corresponds to a data block, which corresponds to a command, for example, for controlling an automation component. The data block, for example, effects the start or the stop or contains a parameter record to parameterize an automation component provided for this purpose such as a motor, inverter etc.

OFDM symbols 15, 16, 17 are conducted via a first transmission buffer 31, a digital-analog converter D/A and a first current driver 31 to a first coupling device 40. First coupling device 41 couples the data signal, which corresponds to OFDM symbols 15, 16, 17 or to telegram 14, into line 3, preferably in a contactless manner.

The data signal may now be received by a second modem 2. For this purpose, second modem 2 has a receiver 12. Receiver 12 includes an additional second coupling device 61 for coupling the data signal out of line 3, preferably in a contactless manner. The data signal is then filtered by a second band-pass filter 56 and transmitted to an analog-digital converter A/D.

The data signal conditioned in this manner is then transmitted via a second receiving buffer 54 to an OFDM demodulator, which passes the data obtained from the data signal on to a data sink or the appropriately designed automation component. The automation component executes the corresponding command.

For the bidirectional communication between first and second modem 1, 2, second modem 2 accordingly has an OFDM modulator, a second transmission buffer 50, a digital-analog converter D/A, a second current driver 51 and a second coupling device 60. For receiving signals, the first modem has an additional first coupling device 41, a first band-pass filter 36, a first receiving amplifier 38, an analog-digital converter A/D and a first receiving buffer 34. The data signal is demodulated in an OFDM demodulator accordingly as in second modem 2, and the data thereby obtained are transmitted to a data sink.

Transmitter 10 and additional receiver 22 of first modem 1 or additional transmitter 20 and receiver 12 of second modem 2 may respectively use a common coupling device.

The respectively utilized coupling devices may have suitably designed coils and/or capacitors in order to couple inductively and/or capacitively to line 3.

The OFDM symbols are repeated n-fold in first transmission buffer 30, for example with the aid of a FIFO element (First In First Out). Transmitter 10 thus produces a telegram in which each OFDM symbol is transmitted in n-fold repetition. n is preferably an integer between 1 and 5.

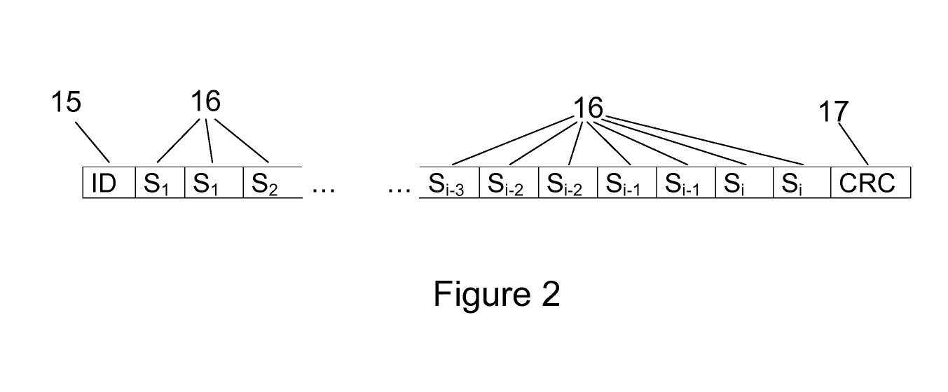

FIG. 2 schematically shows a telegram 14 having an ID OFDM symbol 15 for identifying the telegram or the receiver, various command OFDM symbols S₁, S₂, . . . Sᵢ, 16 for the actual data transmission and a CRC OFDM symbol 17 as a control symbol.

In the exemplary embodiment shown in FIG. 2, the ID OFDM symbol 15 and the CRC OFDM symbol 17 occur only once in telegram 14. In additional exemplary embodiments, these OFDM symbols 15, 17 are also transmitted repeatedly.

Telegram 14 with the n-fold repeated command OFDM symbols 16 is received by receiver 12 of second modem 2 using the additional second coupling device 61. Second receiving buffer 54 adds the n-fold repeated command OFDM symbols 16 in a symbol-wise manner in phase, which command OFDM symbols were conditioned by second band-pass filter 56, by second receiving amplifier 58 and analog-digital converter A/D.

For the telegram shown in FIG. 2, this means concretely that the OFDM symbols having the same subscript “1, 2, . . . , i-3, i-2, i-1, i” are added in phase. Thus, the two command OFDM symbols 16 S₁, for example, are combined into a single command OFDM symbol S₁.

The combined i OFDM symbols are then demodulated by OFDM demodulator OFDM Demod and supplied to the data sink as a data stream or command. This results in an improved signal-to-noise ratio, which in the case of strong disturbances in particular in a power line transmission in industrial surroundings results in an error-resistant data transmission and in some cases makes such a data transmission possible in the first place.

The second modem may have an evaluation device 52. Evaluation device 52 is supplied with the received data signal, in particular a test signal, of transmitter 10 behind second receiving amplifier 58, as shown schematically in FIG. 1.

Preferably, the test signal is transmitted in an initialization of the method for data transmission. Evaluation device 52 in receiver 12 determines a signal strength, in particular an amplitude or energy, of the test signal. Evaluation device 52 may determine from the signal strength the rate of repetition of the OFDM symbols.

For example, in the case of a received signal strength in comparison to a reference signal strength stored in the evaluation device of 0 dB, the OFDM symbols are transmitted once, up to −10 dB they are transmitted twice, up to −20 dB are transmitted three times, and up to −30 dB are transmitted four times. Evaluation device 52 communicates the rate of repetition, that is, how often the OFDM symbols must be transmitted, to second transmission buffer 50 and second receiving buffer 54. Second transmission buffer 50 and second receiving buffer 54 are thus able to duplicate or receive the OFDM symbols accordingly.

Additionally, second modem 2 communicates the rate of repetition to first modem 1 so that transmitter 10 and additional receiver 22 process the OFDM symbols accordingly.

Receiver 12 may communicate the signal strength to transmitter 10 and an additional evaluation device 32 in transmitter 10.

Additional evaluation device 32 determines the rate of repetition of the OFDM symbols from the signal strength. Afterwards, additional evaluation device 32 communicates the required rate of repetition that is to be applied to first transmission buffer 30 and first receiving buffer 34. This rate of repetition is subsequently also communicated by transmitter 10 of first modem 1 to second modem 2 such that there too second transmission buffer 50 and second receiving buffer 54 are able to duplicate or receive the OFDM symbols accordingly.

The signal strength of the test signal depends primarily on the transmission characteristic of a transmission medium, of line 3 for example. The rate of repetition is thus ascertained as a function of the transmission characteristic of the transmission medium.

The test signal is preferably a signal with chirp. The mathematical description of the test signal contains the term sin (ω t+φ(t)) for example. φ(t) means that the phase is time-dependent. A signal with chirp changes its frequency over time. With respect to the test signal, this has the advantage that a wide frequency range of the transmission characteristics of the transmission medium is detected using a single test signal. The test signal is preferably a time-limited voltage pulse and/or current pulse, which has a duration in particular of up to 200 microseconds.

An OFDM symbol is composed in the frequency range from multiple subcarriers, which are orthogonal with respect to one another. The subcarriers form subsymbols, from which the OFDM symbol is composed.

The advantage of the chirp signal as a test signal is that a test signal determines the transmission characteristics of the transmission medium in a greater frequency range. If the test signal is evaluated in a frequency-selective manner, for example by determining the signal strength as a function of frequency, then it is also possible to determine and optimize the rate of repetition separately for each subcarrier in a frequency-selective manner.

In a device having a data transmission system 5, line 3 is preferably arranged as an extended closed conductor loop. Movable consumers, especially movably disposed electric motors, are situated along this conductor loop. The consumers respectively have one modem, which is arranged in accordance with first modem 1.

The modem couples an alternating current component in a frequency range into the conductor loop. The frequency range is preferably in the MHz range, in particular between 0.5 MHz and 8 MHz. The amplitude of the alternating current component, or, in other words, the data signal amplitude in the current conductor, is up to 10 milliamperes.

The alternating current component is used for data transmission. An additional alternating current component having a frequency is fed into the conductor loop for energy transmission. For this purpose, an inverter is preferably connected to the conductor loop. The frequency is preferably in the range of 10 kHz to a few hundred kHz, particularly preferably between 20 kHz and 200 kHz. The amplitude of the additional alternating current component is in the range between a few amperes and a few hundred amperes, preferably between 50 amperes and 100 amperes.

The inverter feeds pulse-like periodic disturbances into the conductor loop. These are determined by the switching element in the inverter. The impulsive disturbances are arranged in particular in pairs, a fixed time interval existing between the pairs, and the time interval fluctuating between the impulsive disturbances of the pair. The fixed time interval corresponds to the frequency.

In a simultaneous usage of the method for data transmission and energy transmission via the same line, the length in time of an OFDM symbol corresponds to a half period of the frequency. Thus it is possible simply to eliminate the strong impulsive disturbances in the addition of the repeatedly transmitted OFDM symbols. Since the time interval within a pair fluctuates, the impulsive disturbances lie in different time segments of the repeated OFDM symbol.

Thus the additional alternating current component is fed into the same line 3, and the data signal is contactlessly fed in and coupled out of the same line 3.

The consumers respectively have a secondary winding, from which the respective consumer is supplied with energy. The secondary winding is inductively coupled to the conductor loop. A capacitor is connected in series and/or in parallel to the secondary winding such that a resonant frequency of the circuit made up of secondary winding and capacitor has a resonant frequency corresponding to the frequency.

Every consumer and/or the control unit respectively has a modem corresponding to first modem 1. Thus, the corresponding components of the consumers and/or of the control system form a data transmission system.

The data transmission system uses the method for data transmission by orthogonal frequency multiplexing (OFDM) between transmitter 10 and receiver 12 using a data signal.

The data signal has telegram 14, which is made up of OFDM symbols.

The OFDM symbols are transmitted by transmitter 10 in symbol-wise fashion at a rate of repetition in n-fold succession within telegram 14 Upon reception in receiver 12, the respectively n-fold successively transmitted OFDM symbols are added symbol-wise in phase.

A disturbance detector in receiver 12 and/or in transmitter 10 may detect a time-related impulsive disturbance in the transmission medium. The disturbance detector is for example arranged as a peak voltage detector and triggers a counting pulse if the voltage in line 3 exceeds a specified voltage.

In this example embodiment of the method, the rate of repetition of the OFDM symbols is either defined as a function of the rate of occurrence of the time-related impulsive disturbance, or the rate of repetition of the OFDM symbols is determined as a function of the signal strength and the rate of occurrence of the time-related impulsive disturbances.

In this method too, the OFDM symbols are transmitted in symbol-wise fashion at a rate of repetition n-fold in succession within telegram 14, and as they are received, the OFDM symbols transmitted repeatedly in succession are added symbol-wise in phase.

In the event of a change of the transmission route for the data signal as a result of a movement of transmitter 10 and/or receiver 12, the data transmission system is arranged such that transmitter 10 detects the change and an initialization is performed.

Sensors may be provided, for example, along the route of transmitter 10 and/or receiver 12 for detecting the change.

In other cases, the transmission route may change, for example, by switching a route switch. This change of the transmission route may be detected in that corresponding signal propagation times are measured or signals are communicated by sensors at the switch to the transmitter or a signal regarding to the switching action is communicated directly to the transmitter by the switch control unit.

The renewed transmission of a test signal may be triggered also by undershooting a signal strength of the data signal.

The described methods may be used in any device having transmitters and receivers. This applies particularly if the transmitters and/or receivers are movable relative to a line 3 and communicate with one another and with a control unit via line 3 by the method.

A preferred use for the device is a monorail conveyor. The consumers in this case are arranged as traveling carriages, which respectively include a motor and a modem.

1-15. (canceled)

16. A method for data transmission by an orthogonal frequency multiplexing (OFDM) between a transmitter and a receiver using a data signal, the data signal having a telegram including OFDM symbols, comprising:
transmitting the OFDM symbols by the transmitter in symbol-wise fashion at a rate of repetition in n-fold succession within a telegram; and
during receiving in the receiver, adding the respectively n-fold successively transmitted OFDM symbols symbol-wise in phase.

17. The method according to claim 16, further comprising ascertaining a rate of repetition as a function of a transmission characteristic of a transmission medium of the data signal.

18. The method according to claim 17, further comprising:
transmitting a test signal in an initialization of the method;
determining a signal strength and/or an amplitude of the test signal by an evaluation device in the receiver; and
(a) determining, by the evaluation device, the rate of repetition of the OFDM symbols from the signal strength, and communicating, by the receiver, the rate of repetition to the transmitter; or (b) communicating, by the receiver, the signal strength to the transmitter and determining, by an additional evaluation device in the transmitter, the rate of repetition of the OFDM symbols from the signal strength.

19. The method according to claim 18, wherein the test signal includes a signal with chirp.

20. The method according to claim 16, wherein the rate of repetition is ascertained separately for different transmission frequencies.

21. The method according to claim 2, further comprising:
detecting, by a disturbance detector in the receiver and/or in the transmitter, a time-related impulsive disturbance in the transmission medium; and
(a) determining, by the disturbance detector, the rate of repetition of the OFDM symbols as a function of a rate of occurrence of the time-related impulsive disturbance; or (b) determining, by the disturbance detector, the rate of repetition of the OFDM symbols as a function of the signal strength and the rate of occurrence of the time-related impulsive disturbances.

22. The method according to claim 16, further comprising detecting a change of a transmission route for the data signal as a result of a movement of the transmitter and/or the receiver, and performing an initialization.

23. A method, comprising:
transmitting data by orthogonal frequency multiplexing (OFDM) method between a transmitter and a receiver via an alternating current component and transmitting electrical energy via an additional alternating current component using at least partially the same line, a data signal including OFDM symbols for data transmission, the additional alternating current component including a frequency;
wherein a length in time of an OFDM symbol corresponds to a half-period of the frequency.

24. The method according to claim 23, further comprising:
transmitting the OFDM symbols in symbol-wise fashion at a rate of repetition n-fold in succession; and
during receiving, adding the OFDM symbols transmitted repeatedly in succession symbol-wise in phase.

25. The method according to claim 23, further comprising:
transmitting the OFDM symbols by the transmitter in symbol-wise fashion at a rate of repetition in n-fold succession within a telegram; and
during receiving in the receiver, adding the respectively n-fold successively transmitted OFDM symbols symbol-wise in phase.

26. The method according to claim 23, further comprising:
feeding the additional alternating current component into the same line; and
contactlessly feeding the data signal into the same line and coupling out the data signal of the same line.

27. A data transmission system, comprising:
a transmitter; and
a receiver;
wherein the transmitter and receiver are adapted to perform method for data transmission by orthogonal frequency multiplexing (OFDM) between the transmitter and the receiver using a data signal, the data signal having a telegram including OFDM symbols;
wherein the transmitter is adapted to transmit the OFDM symbols in symbol-wise fashion at a rate of repetition in n-fold succession within a telegram; and
wherein the receiver is adapted to add the respectively n-fold successively transmitted OFDM symbols symbol-wise in phase.

28. A data transmission system, comprising:
a transmitter adapted to transmit data by orthogonal frequency multiplexing (OFDM) between the transmitter and a receiver via an alternating current component and transmitting electrical energy via an additional alternating current component using at least partially the same line, a data signal including OFDM symbols for data transmission, the additional alternating current component including a frequency;
wherein a length in time of an OFDM symbol corresponds to a half-period of the frequency.

29. A device, comprising:
transmitters; and
receivers;
wherein the transmitters and/or receivers are adapted to move relative to a line and to communicate among one another and with a control unit via the line in accordance with the method recited in claim 16.

30. A device, comprising:
transmitters; and
receivers;
wherein the transmitters and/or receivers are adapted to move relative to a line and to communicate among one another and with a control unit via the line in accordance with the method recited in claim 23.

31. A device, comprising:
consumers movable along an extended closed conductor loop, an alternating current component in a frequency range in the conductor loop being usable for data transmission, an additional alternating current component being feedable into the conductor loop at a frequency for energy transmission, the consumers respectively including a secondary winding, from which the respective consumer is suppliable with energy, the secondary winding being coupled inductively to the conductor loop and a capacitor being connected in series and/or in parallel to the secondary winding such that a resonant frequency of a circuit made up of the secondary winding and the capacitor has a resonant frequency corresponding to the frequency;
wherein the consumers and/or the control unit have a data transmission system as recited in claim 28.

32. The device according to claim 31, wherein the device is arranged as a monorail conveyor and each consumer includes a motor and a traveling carriage.
